(19) United States
(12) Patent Application Publication
(10) Pub. No.: US 2026/0023255 A1
(43) Pub. Date: Jan. 22, 2026

(54) IMAGING DEVICE AND METHOD

(71) Applicant: Leica Microsystems CMS GmbH, Wetzlar (DE)

(72) Inventor: Peter LASKEY, Wetzlar (DE)

(21) Appl. No.: 18/992,192

(22) PCT Filed: Jul. 4, 2023
(86) PCT No.: PCT/EP2023/068289

§ 371 Date: Jan. 8, 2025

(30) Foreign Application Priority Data
Jul. 12, 2022 (DE) 10 2022 117 270.8

(51) Int. Cl. G02B 21/36; H04N 23/54

(52) U.S. Cl. CPC G02B 21/361; H04N 23/54

(57) ABSTRACT

An imaging device for imaging a sample includes an image sensor having a sensor area for receiving detection light from the sample, and configured to generate an image from the detection light received by an active area. The active area is at least a part of the sensor area of the image sensor. The imaging device further includes a camera adapter configured to mount the image sensor, and a controller configured to determine a magnification of the camera adapter, determine a size of the sensor area of the image sensor, and set a size of the active area based on the magnification of the camera adapter and the size of the sensor area.

### CROSS REFERENCE TO RELATED APPLICATIONS

This application is a U.S. National Phase application under 35 U.S.C. § 371 of International Application No. PCT/EP2023/068289, filed on Jul. 4, 2023, and claims benefit to German Patent Application No. DE 10 2022 117 270.8, filed on Jul. 12, 2022. The International Application was published in English on Jan. 18, 2024 as WO 2024/012922 A1 under PCT Article 21(2).

### FIELD

Embodiments of the present invention relate to an imaging device, to a method for controlling an imaging device, and to a computer program product.

### BACKGROUND

Microscopes are optical instruments for observing samples. An optical detection system of a microscope typically comprises an objective directed at the sample for collecting detection light from the sample. The collected detection light is then directed via a tube lens of the optical detection system into an eyepiece through which a user may observe the sample. To generate digital images, a digital camera may be used. The sensor of the digital camera typically comprises a rectangular array of photosensors. These photosensors are referred to as pixels, since they relate to the pixels in the digital image generated by the digital camera. The physical size of the photosensors is called pixel size or pixel pitch. The smaller the pixel size, the higher the resolution of the digital camera at a constant area of the sensor. However, a smaller pixel size also means less area per pixel, and thus that the individual pixels are less sensitive to light and the signal to noise ratio is lower.

The digital camera either replaces the eye piece, or the beam path originating from the objective is split into a beam path continuing to the eye piece, and another beam path continuing to the digital camera. In either case, a camera adapter is typically used to mount the digital camera to the microscope. The camera adapter may be magnifying or de-magnifying to adapt an optical image generated by the optical imaging system to the physical sensor dimensions of the digital camera. However, adapting the digital camera to the microscope and the specific application requires experience and familiarity with the microscopes optical detection system and the digital camera, making it difficult for an unexperienced user to do so.

### SUMMARY

Embodiments of the present invention provide an imaging device for imaging a sample. The imaging device includes an image sensor having a sensor area for receiving detection light from the sample, and configured to generate an image from the detection light received by an active area. The active area is at least a part of the sensor area of the image sensor. The imaging device further includes a camera adapter configured to mount the image sensor, and a controller configured to determine a magnification of the camera adapter, determine a size of the sensor area of the image sensor, and set a size of the active area based on the magnification of the camera adapter and the size of the sensor area.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic view of an imaging device according to an embodiment;

FIG. 2 is a flowchart of the method for controlling the imaging device of FIG. 1, according to some embodiments;

FIG. 3 shows the size of a field of view of the imaging system of FIG. 1 compared to the size of two sensor areas, according to some embodiments;

FIG. 4 shows the size of another field of view of the imaging system of FIG. 1 compared to the size of the two sensor areas, according to some embodiments; and

FIG. 5 shows the size of the field of view according to FIG. 4 compared to the size of a second sensor area and the size of an active area of the second sensor area, according to some embodiments.

### DETAILED DESCRIPTION

Embodiments of the present invention provide an imaging device and a method for controlling an imaging device that are very easy to use, in particular by an unexperienced user.

The imaging device for imaging a sample comprises an image sensor element having a sensor area for receiving detection light from the sample, and being configured to generate an image from the detection light received by an active area, wherein the active area is at least a part of the sensor area of the image sensor element. The imaging system further comprises a camera adapter configured to mount the image sensor element, and a controller. The controller is configured to determine a magnification of the camera adapter, to determine the size of the sensor area of the image sensor element, and to set the size of the active area based on the magnification of the camera adapter and based on the size of the sensor area.

The imaging device collects detection light emitted by the sample and generates an optical image of the sample in a plane that is coplanar with the sensor area, also called the detection plane in the following. The optical image generated in the detection plane is converted by image sensor element into electronic signal, for example in form of a digital image. Typically, the magnification of the camera adapter is chosen based on the size of the sensor area such that the size of the optical image generated in detection plane best matches the size of the sensor area. This makes optimum use of the sensor area allowing to image the sample at a high resolution while a black border in the image generated by the image sensor element.

However, it has been recognized that it is beneficial to choose the magnification of the camera instead according to the specific application the imaging device is used for. For example, by using a de-magnifying camera adapter, i.e. a camera adapter having a magnification of less than 1×, more light is bundled towards a single pixel of the image sensor element. Thereby, an effective pixel size of the image sensor element is increased, i.e. the size of the area of the sample that is imaged onto a single pixel. This increases the signal to noise ratio and can be used to great effect for example in fluorescence imaging applications where photon counts are typically very low. It has further been recognized that it is beneficial to use image sensor elements having a large pixel size and a large sensor area. The pixel size is directly linked with the dynamic range of the image sensor element. Thus, in addition to an increased sensitivity to light, a large pixel size results in a high dynamic range allowing for higher quality imaging. A large sensor area can fit more pixels resulting in a higher resolution. It is therefore desirable to choose the magnification of the camera adapter and the size of the sensor area independently of each other.

The controller of the proposed imaging device automatically adjusts the size of the active area of the sensor area, i.e. the area that is read out to generate for example the digital image, according to the magnification of the camera adapter. For example, when a de-magnifying camera adapter is used, the controller selects a smaller active area to prevent a black border around the image. Similarly, when a magnifying camera adapter is used, the controller selects a bigger active area to make optimum use of the sensor area, and to generate a high-resolution image. With the proposed imaging device, a user is able to freely choose magnification of the camera adapter and the size of the sensor area according to the needs of a specific application. The controller automatically selects the optimal size of the active area, making the imaging device very easy to use, in particular by an unexperienced user. In other words, the controller automatically presents the best possible optical solution the imaging device can offer. This automation offers great freedom to adjust the imaging device to best match specific applications. For example, employing high resolution large format image sensor elements for a range of different applications.

According to an embodiment, the controller is configured to set the size of the active area such that the active area matches the current field of view of the imaging device. The current field of view of the imaging device may be circular, and the active area of the may be rectangular. The controller may in particular be configured to set the size of a diagonal of the active area such that the active area matches a diameter of the current field of view of the imaging device. In the present document, the current field of view of the imaging device is understood to be the optical image generated by the imaging device in the detection plane as opposed to an area in the sample currently imaged by the imaging device. Accordingly, the diameter of the current field of view is understood to be the diameter of the optical image generated by the imaging device in the detection plane. In this embodiment, the controller is configured to match the size of the active area to the size of the optical image generated in the detector plane. This prevents the generation of a black border in the image due to reading out a part of the sensor area where no image is formed while making optimum use of the sensor area. Thus, the imaging device can be used for generating high quality images of the sample.

According to another embodiment, the imaging device comprises a first camera port with a first field of view. The first camera port is configured to receive the camera adapter so that when the camera adapter is arranged between the first camera port and the image sensor element the current field of view of the imaging device is defined by the first field of view.

According to another embodiment, the imaging device comprises a second camera port with a second field of view, the second camera port being configured to receive the camera adapter so that when the camera adapter is arranged between the second camera port and the image sensor element the current field of view of the imaging device is defined by the second field of view. The controller is configured to set the size of the active area based on whether the camera adapter is arranged on the first camera port or second camera port. The diameter of the optical image generated by the imaging device in the detection plane may be different for each camera port. Accordingly, by taking into account which camera port the image sensor element is mounted to, the generation of a black border in the image is prevented while making optimum use of the sensor area.

According to another embodiment, the controller is configured to detect a change of the camera adapter, and upon on a detected change of the camera adapter to set the size of the active area based on the changed camera adapter. The controller may also be configured to detect a change of the image sensor element, and upon on a detected change of the image sensor element to set the size of the active area based on the changed image sensor element. The controller automatically detects when the camera adapter and/or the image sensor element is switched, and redetermines size of the active area based for example on the magnification of the new camera adapter or the size of the sensor area of the new image sensor element, respectively. The controller automatically performs the redetermination of the size the active area, thereby making the imaging device even easier to use.

According to another embodiment, the imaging device comprises an optical detection system configured to receive the detection light from the sample, and to direct the detection light onto the sensor area of the image sensor element via the camera adapter. The optical detection system may comprise an objective directed at the sample, and a tube lens arrange between the objective and the camera adapter. The optical detection system comprises the optical elements for capturing the detection light from the sample and for forming the optical image of the sample in the detection plane.

According to another embodiment, the controller is configured to set the size of the active area based on an optical parameter of the optical detection system. The optical parameter is in particular a magnification of the camera adapter and/or the objective. The controller may be configured to receive the optical parameter, for example via the user input unit. Alternatively, the optical parameter may be stored on a memory element. The memory element may be arranged in the imaging device or in the element the optical parameter is associated with, for example the camera adapter or the objective. Taking the optical parameter into account when the size of the active area prevents a black border in the image while making optimum use of the sensor area.

According to another embodiment, the controller is configured to detect a change of the optical parameter of the optical detection system, and upon on a change of the optical parameter of the optical detection system to set the size of the active area based on the changed the optical parameter. In this embodiment, the controller automatically detects a change in the optical detection system, and redetermines size of the active area based for the new value of the changed optical parameter. The user does not need to know whether a redetermination of the size the active area is necessary. This makes the imaging device even easier to use.

According to another embodiment, the imaging device comprises a user input unit configured to receive a user input. The controller may be configured to determine the magnification of the camera adapter and/or the size of the sensor area of the image sensor element based on the user input. The controller may also be configured to determine the optical parameter of the optical detection system based on the user input.

According to another embodiment, the imaging device comprises a housing; wherein the camera adapter is configured to mount the image sensor element to the housing of the imaging device. Preferably, the camera adapter is a c-mount, f-mount or t-mount adapter. C-mounts, f-mounts, and t-mounts are standardized elements used widely in microscopy and adjacent fields. This means that the imaging device is compatible with readily available parts, making the imaging device very versatile.

According to another embodiment, the camera adapter has a magnification in the range from 0.25× to 2×. The range according to this embodiment provides sufficient magnification or de-magnification for adapting the optical image of the sample generated in the detection plane to the image sensor element. Camera adapter having a magnification in this range are readily available, making the imaging device more cost effective to manufacture.

According to another embodiment, the imaging device is configured for fluorescence imaging. In fluorescence imaging, fluorophores located in the sample are excited to emit fluorescence light. The fluorescence light emitted by the sample is then used to generate an image of the sample. Typically, the photon count, i.e. amount of fluorescence light received by the image sensor element in fluorescence imaging experiments is very low. A single pixel of the image sensor element may detect as little as 10 to 50 photons of the fluorescence light. It is therefore vital to increase the signal to noise ratio in imaging devices used for fluorescence imaging. The proposed imaging system may be very easily used with a de-magnifying camera adapter to increase the signal to noise ratio without the need for further adjustments by the user. This makes the imaging device well suited for fluorescence imaging.

According to another embodiment, the imaging device is a microscope. However, the imaging device is not limited to be a microscope. For example, the imaging device may also be a slide scanner, a flow cytometer, a DNA sequencer, or any other imaging device comprising an adapter for an image sensor element such as a digital camera.

Embodiments of the invention also relate to a method for controlling an imaging device. The method comprises the following steps: Determining a magnification of a camera adapter mounting an image sensor element of the imaging device. Determining the size of a sensor area of the image sensor element. Setting the size of an active area of the image sensor element based on the magnification of the camera adapter and the size of the sensor area; wherein the active area is at least a part of the sensor area of the image sensor element.

The method has the advantages as the imaging device described above and can be supplemented using the features of the dependent claims directed at the imaging device.

Embodiments of the invention further relate to a computer program product comprising a program code configured to perform the method described above, when the computer program product is run on a processor.

The computer program product has the same advantages as the imaging device and the method described above, and can be supplemented using the features of the dependent claims directed at the imaging device and the method for controlling an imaging device, respectively.

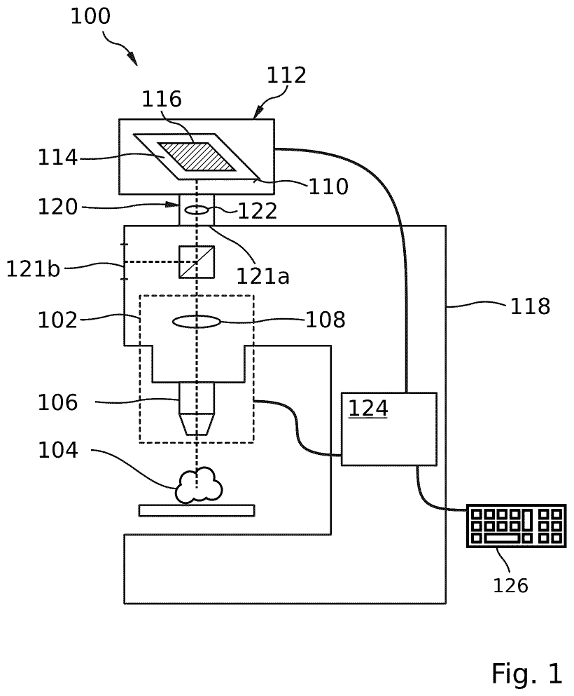

FIG. 1 is a schematic view of an imaging device 100 according to an embodiment.

The imaging device 100 according to FIG. 1 is exemplary formed as a microscope and comprises an optical detection system 102 for forming an optical image of a sample 104. The optical detection system 102 comprises an objective 106 directed at the sample 104, and a tube lens 108 arranged in the beam path following the objective 106. The objective 106 is configured to collect detection light from the sample 104. The collected detection light is then directed via the tube lens 108 to a detection plane 110 where the optical image of the sample 104 is formed. This optical image of the sample 104 formed in the detection plane 110 is also referred to as the current field of view of the imaging device 100 since it encompasses the extend of what is currently visible to the imaging device 100.

The imaging device 100 further comprises an image sensor element 112. The image sensor element 112 has a sensor area 114 that is arranged in the detection plane 110, and comprises a two-dimensional area of photosensors. The photosensors are also called pixels and convert the detection light into an electronic signal. Since the sensor area 114 is arranged in the detection plane 110, the image sensor element 112 converts the optical image of the sample 104 formed in the detection plane 110 into an electronic signal, for example in form of a digital image. The part of the sensor area 114 that is actively read out in order to generate the electronic signal is called the active area 116. The active area 116 may be as big as the entire sensor area 114.

The image sensor element 112 is mounted to a housing 118 of the imaging device 100 by a camera adapter 120. Exemplary, the image sensor element 112 is mounted to a first camera port 121a of the imaging device 100. The imaging device 100 also comprises a second camera port 121b. The size of the optical image of the sample 104 formed in the detection plane 110 may depend on which of the camera port 121a, 121b the image sensor element 112 is mounted to.

The camera adapter 120 comprises optical elements 122 shown as single lens in FIG. 1 for the sake of clarity. The optical elements 122 of the camera adapter 120 are configured for adapting the image sensor element 112 to the optical detection system 102. In particular, the optical elements 122 of the camera adapter 120 provide a magnification or demagnification, typically in the range between 0.25× and 2×. The magnification of the camera adapter 120 may be used to adapt the size of the optical image generated by the optical detection system 102 the size of the sensor area 114 by enlarging or reducing the size of the optical image in the detection plane 110. The camera adapter 120 may also be used to adjust an effective pixel size of the image sensor element 112. The effective pixel size is the size of an area, typically denoted by its diameter, of the sample 104 that is imaged onto a single pixel of the sensor area 114 by the optical detection system 102. Increasing the effective pixel size decreases the resolution of the imaging device 100 since a larger area of the sample 104 is imaged to a single pixel of the image sensor element 112.

However, increasing the effective pixel size increases the signal to noise ratio which is beneficial in application where only small amount of light is detected, such as fluorescence microscopy. For example, the camera adapter 120 is a 1× camera adapter, i.e. the camera adapter 120 does provide neither magnification nor de-magnification, the objective 106 has a magnification of 63×, and the pixel size of the image sensor element 112 is 4.5 μm. In this example, the effective pixel size is about 71 nm per pixel, i.e. an area having a diameter of about 71 nm is imaged to one pixel of the image sensor element 112. In an exemplary low light fluorescence microscopy application, around 20 photons are emitted from an area that size. Accordingly, each pixel detects about 20 photons. Assuming a read noise of 2 e-, this results in a signal to noise ratio of 10/1. In a different example, a 0.7× camera adapter is used as the camera adapter 120 instead. In this example, the effective pixel size is increased to 102 nm per pixel. In a typical fluorescence microscopy application, around 41 photons are emitted from an area that size. Accordingly, each pixel detects about 41 photons, meaning the signal to noise ratio is increased to 20/1. As can be seen from these two examples, a de-magnifying camera adapter, i.e. a camera adapter having a magnification of less than 1, can be used to increase the signal to noise ratio, in particular in applications such as fluorescence microscopy where the photon count is very small.

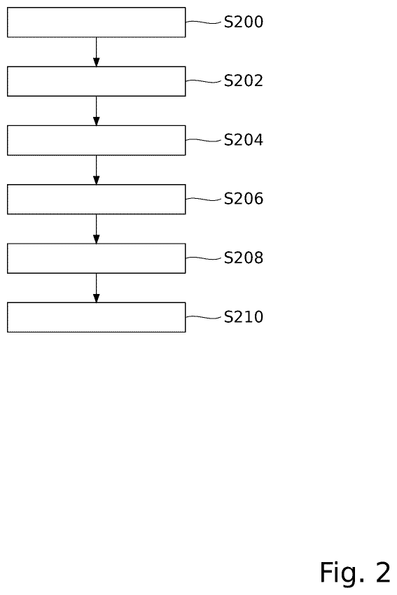

The imaging device 100 further comprises a controller 124, and an input device 126. The input device 126 is connected to the controller 124 and is exemplary shown to be a keyboard. The controller 124 is configured to receive a user input via the input device 126. The controller 124 is further configured to control the optical detection system 102 and the image sensor element 112 in order to image the sample 104. In particular, the controller 124 is configured to set the size of the active area 116 of the sensor area 114 based on the magnification of the camera adapter 120. An exemplary method for controlling the imaging device 100 by setting the size of the active area 116 that may be performed by the controller 124 is described below with reference to FIGS. 2 to 5.

FIG. 2 is a flowchart of the method for controlling the imaging device 100 according to FIG. 1.

In step S200 the process is started. In step S202 the controller 124 determines the magnification of the camera adapter 120 currently mounting the image sensor element 112 to the housing 118 of the imaging device 100. If the imaging system 100 comprises more than one camera port 121a, 121b, the controller 124 also determines which camera port 121a, 121b the image sensor element 112 is currently mounted to. The controller 124 may receive the magnification of the camera adapter 120 via user input. The magnification may be input directly by the user. The user may also input an identifier, for example a model designation, of the camera adapter 120 and the controller 124 may determine the magnification from the identifier. The controller 124 may also be configured to read the magnification and/or the identifier from a memory element of the camera adapter 120. In step S204 the controller 124 determines size of the sensor area 114 of the image sensor element 112. The size of the sensor area 114 may be input directly by a user or read from a memory element of the image sensor element 112. The size of the sensor area 114 may also be determined from an identifier of the image sensor element 112 that is either input by the user or read from the memory element of the image sensor element 112.

In an optional step S206 the controller 124 determines at least one optical parameter of the optical detection system 102 that influences the size of the optical image in the detection plane 110, for example a magnification of the objective 106. Like the magnification of the camera adapter 120, the optical parameter may be input directly by the user or may be inferred by the controller 124 from an identifier of an optical element associated with the optical parameter. The controller 124 may also be configured to read the optical parameter and/or the identifier from a memory element of the associated optical element or the imaging device 100. The steps S202, S204, and S206 may be performed concurrently or consecutively in any order. The controller may further be configured to detect a change in the system configuration of the imaging device 100. For example, the controller may be configured to detect whether the camera adapter 120, the image sensor element 112 or the objective 106 have been changed. The controller may then perform any of the steps S202, S204, and S206 again, in order to obtain the current values of the parameters determined in these steps.

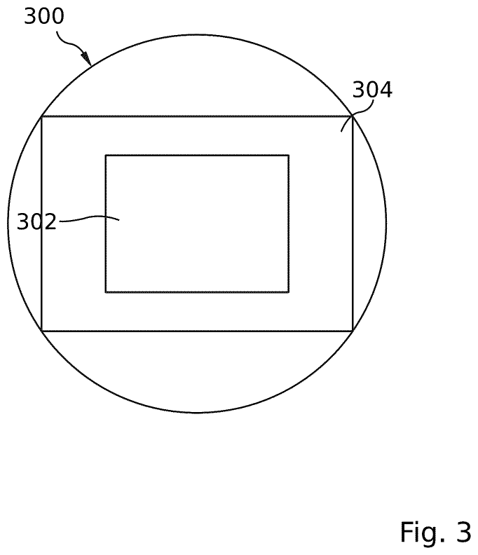

In step S208 the controller 124 determines the size of the optical image formed by the optical detection plane 110 in the detection plane 110 based on the information determined in steps S202, S204, and S206. Since the elements of the optical detection system 102 are typically symmetrical around their respective optical axis, the optical image formed in the detection plane 110 is circular. The size of the optical image formed in the detection plane 110 is therefore given by its diameter. In step S210 the controller 124 sets the size of the active area 116 of the sensor area 114 to match the size of the optical image formed in the detection plane 110. In other word, the controller 124 matches the size of the active area 116 to the current field of view of the imaging device 100. The active area 116 is rectangular and the size of the active area 116 is determined by its diagonal and its aspect ratio. The controller 124 therefore sets the diagonal of the active area 116 to match the diameter of optical image formed in the detection plane 110. Since the sensor area 114 is comprised of pixel of a finite size, it may not be possible to perfectly match the diagonal of the active area 116 to match the diameter of optical image. In such a case, the diagonal of the active area 116 is chosen such that it is as large as possible while still being smaller than the diameter of optical image, in order to prevent a black border forming in the image. The aspect ratio of the active area 116 may be chosen freely. However, certain standard formats exist, for example 1:1, 4:3, 14:9, 16:10, 16:9 etc., from which the user may chose according to the present application. In step S210 the process is stopped. The method is further explained below with reference to FIGS. 3 to 5.

FIG. 3 shows the size of a field of view 300 of the imaging system according to FIG. 1 compared to the size of two sensor areas 302, 304.

The field of view 300 of the imaging system is circular and shown in FIG. 3 as a circle drawn with solid black line. The size of the field of view 300 is determined by the optical parameters of the optical detection system 102 and by the magnification of the camera adapter 120. In FIG. 3, the magnification of the camera adapter 120 is 1× and the diameter of the field of view 300 is about 17.6 mm.

A first sensor area 302 comprises 2.8 million pixels, each pixel having a pixel size of 4.5 μm. The first sensor area 302 has a diagonal of 10.9 mm. Accordingly, the first sensor area 302 is smaller than the field of view 300. An image captured by the first sensor area 302 encompasses only a portion of the field of view 300.

A second sensor area 304 comprises 7 million pixels, each pixel having a pixel size of 4.5 μm. The second sensor area 304 has a diagonal of 17.6 mm matching the diameter of the field of view 300. An image captured by the second sensor area 304 encompasses a large portion of the field of view 300, larger than the image captured by the first sensor element.

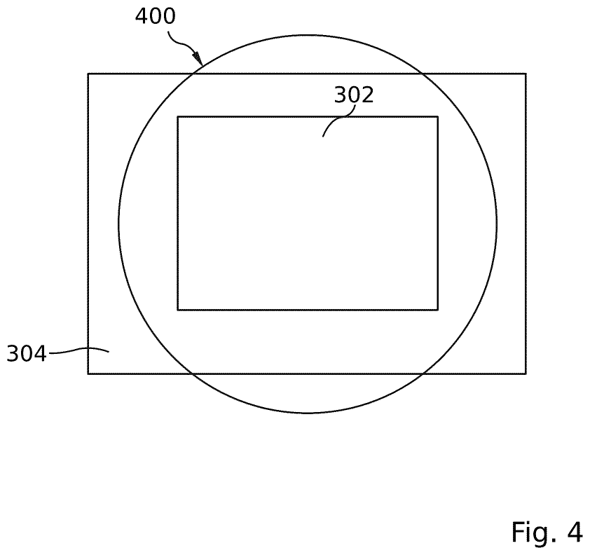

FIG. 4 shows the size of another field of view 400 of the imaging system according to FIG. 1 compared to the size of the two sensor areas 302, 304.

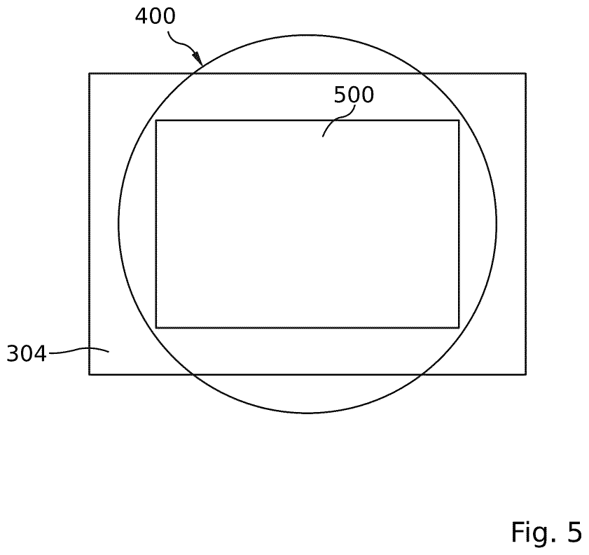

In FIG. 4, the magnification of the camera adapter 120 is 0.76×. This de-magnification reduces the size of the optical image generated in the detection plane 110 by 0.76. Accordingly, the diameter of the field of view 400 is about 13.4 mm. While the first sensor area 302 still fits within the field of view 400, the second sensor area 304 extends outside the field of view 400. In the parts of the second sensor area 304 outside the field of view 400, no detection light from the sample 104 is received resulting in a black border around the image. In order to prevent this black border, the method described above with reference to FIG. 2 is performed. This will be explained in the following with reference to FIG. 5.

FIG. 5 shows the size of the field of view 400 according to FIG. 4 compared to the size of the second sensor area 304 and the size of an active area 500 of the second sensor area 304.

When performing the method according to FIG. 2, the controller 124 sets the active area 500 of the second sensor area 304 to match the field of view 400. The result of the matching is shown in FIG. 5. The active area 500 has a diagonal of about 13.4 mm, thereby fitting inside the field of view 400. In other words, the active area 116 is cropped to the size of the field of view 400. When an image is captured by the second sensor area 304, no black border occurs.

Identical or similarly acting elements are designated with the same reference signs in all Figures. As used herein the term “and/or” includes any and all combinations of one or more of the associated listed items and may be abbreviated as “/”. Individual features of the embodiments and all combinations of individual features of the embodiments among each other as well as in combination with individual features or feature groups of the preceding description and/or claims are considered disclosed.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

100 Imaging device
102 Optical detection system
104 Sample
106 Objective
108 Tube lens
110 Detection plane
112 Image sensor element
114 Sensor area
116 Active area
118 Housing
120 Camera adapter
121a, 121b Camera port
122 Optical element
124 Controller
300 Field of view
302, 304 Sensor area
400 Field of view
500 Active area

1. An imaging device for imaging a sample, the imaging device comprising:
an image sensor having a sensor area for receiving detection light from the sample, and configured to generate an image from the detection light received by an active area, wherein the active area is at least a part of the sensor area of the image sensor;
a camera adapter configured to mount the image sensor; and
a controller configured to determine a magnification of the camera adapter, determine a size of the sensor area of the image sensor, and set a size of the active area based on the magnification of the camera adapter and the size of the sensor area.

2. The imaging device according to claim 1, wherein the controller is configured to set the size of the active area such that the active area matches a current field of view of the imaging device.

3. The imaging device according to claim 2, further comprising a first camera port with a first field of view, the first camera port being configured to receive the camera adapter so that, when the camera adapter is arranged between the first camera port and the image sensor, the current field of view of the imaging device is defined by the first field of view.

4. The imaging device according to claim 3, further comprising a second camera port with a second field of view, the second camera port being configured to receive the camera adapter so that, when the camera adapter is arranged between the second camera port and the image sensor, the current field of view of the imaging device is defined by the second field of view, wherein the controller is configured to set the size of the active area based on whether the camera adapter is arranged on the first camera port or the second camera port.

5. The imaging device according to claim 1, wherein the controller is configured to detect a change of the camera adapter, and upon detecting the change of the camera adapter, set the size of the active area based on the changed camera adapter.

6. The imaging device according to claim 1, further comprising an optical detection system configured to receive the detection light from the sample, and direct the detection light onto the sensor area of the image sensor via the camera adapter.

7. The imaging device according to claim 6, wherein the controller is configured to set the size of the active area based on an optical parameter of the optical detection system.

8. The imaging device according to claim 6, wherein the controller is configured to detect a change of the optical parameter of the optical detection system, and upon detecting the change of the optical parameter of the optical detection system, set the size of the active area based on the changed the optical parameter.

9. The imaging device according to claim 1, further comprising a user input unit configured to receive a user input; wherein the controller is configured to determine the magnification of the camera adapter and/or the size of the sensor area of the image sensor based on the user input.

10. The imaging device according to claim 1, wherein the camera adapter is a c-mount adapter, an f-mount adapter or a t-mount adapter.

11. The imaging device according to claim 1, wherein the magnification of the camera adapter is in a range from 0.25× to 2×.

12. The imaging device according to claim 1, wherein the imaging device is configured for fluorescence imaging.

13. The imaging device according to claim 1, wherein the imaging device is a microscope.

14. A method for controlling an imaging device, the method comprising:
determining a magnification of a camera adapter mounting an image sensor of the imaging device;
determining a size of a sensor area of the image sensor; and
setting a size of an active area of the image sensor based on the magnification of the camera adapter and the size of the sensor area; wherein the active area is at least a part of the sensor area of the image sensor.

15. A non-transitory computer-readable medium having a program code stored thereon, the program code, when executed by one or more processors, facilitating performance of a method for controlling an imaging device, the method comprising:
determining a magnification of a camera adapter mounting an image sensor of the imaging device;
determining a size of a sensor area of the image sensor; and
setting a size of an active area of the image sensor based on the magnification of the camera adapter and the size of the sensor area; wherein the active area is at least a part of the sensor area of the image sensor.
